(19) United States
(12) Patent Application Publication
(10) Pub. No.: US 2008/0159224 A1
(43) Pub. Date: Jul. 3, 2008

(54) SUBSCRIBER OF WIRELES SYSTEM AND OPERATION METHOD THEREOF

(75) Inventors: Jhe-Ming Hsu, Taipei City (TW); Yu-Ren Yang, Tainan City (TW); Chi-Chen Lee, Taipei City (TW); Yu-Min Chiu, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: INDUSTRIAL TECHNOLOGY RESEARCH INSTITUTE, Hsinchu (TW)

(21) Appl. No.: 11/745,469

(22) Filed: May 8, 2007

(30) Foreign Application Priority Data
Dec. 29, 2006 (TW) 95149999

(51) Int. Cl. H04Q 7/00

(52) U.S. Cl. 370/331

(57) ABSTRACT

A subscriber of wireless system and the operation method thereof are disclosed. The subscriber includes a buffer, a scheduler, a modem, an MAP decoder, a bandwidth allocator and a PDU constructor. The buffer receives the output data from the upper layer unit thereof. The scheduler is coupled to the buffer and schedules each connection data in the buffer prior to decoding the MAP. The modem provides a signal modulation/demodulation interface. The MAP decoder is coupled to the modem. The bandwidth allocator is coupled to the MAP decoder and allocates a bandwidth to each connection according to the result of decoding the MAP. The PDU constructor is respectively coupled to the bandwidth allocator, the buffer and the modem, so that the PDU constructor reads out the data of each connection to build a data burst according to the bandwidth allocation result of each connection.

### CROSS-REFERENCE TO RELATED APPLICATION

This application claims the priority benefit of Taiwan application serial no. 95149999, filed Dec. 29, 2006. All disclosure of the Taiwan application is incorporated herein by reference.

### BACKGROUND OF THE INVENTION

1. Field of the Invention

The present invention generally relates to a subscriber of wireless system, and more particular, to an operation method of a subscriber of wireless system.

2. Description of Related Art

Take WiMAX system as an example. Worldwide Interoperability for Microwave Access (WiMAX) is a newly emerging wireless broadband network system. The system is operated mainly under the IEEE 802.16 standard established by the Institute of Electrical and Electronic Engineers. In WiMAX, any link between a base station and a subscriber (brief term of subscriber station or subscriber unit) is accomplished through a series of transmitting/receiving frames (brief term of data frames).

In the time division duplex (TDD) mode, a TDD frame duration is constant; in the orthogonal frequency division multiplex (OFDM) mode, a frame duration can be 2.5 millisecond (ms), 4 ms, 5 ms, 10 ms, 12.5 ms and 20 ms; in the orthogonal frequency division multiple access (OFDMA) mode, a frame duration can be 2 ms, 2.5 ms, 4 ms, 5 ms, 8 ms, 10 ms, 12.5 ms and 20 ms. For the WiMAX specification where both of OFDM mode and ODDMA mode are adopted, a frame duration with a current mobile application is 5 ms.

A TDD frame is composed of a downlink subframe (DL subframe) and an uplink subframe (UL subframe), wherein both of a DL subframe and an UL subframe is adjustable. Any DL/UL data between each subscriber of wireless system and the base station thereof is arranged through a downlink MAP (DL-MAP) or an uplink MAP (UL-MAP).

FIG. 1 is an architecture diagram of a conventional subscriber of wireless system. Whenever a base station allocates an uplink bandwidth to the conventional subscriber of wireless system 100, the base station would above all transmit a UL-MAP message in a DL subframe thereto. Hence, the upper layer unit 101 of the conventional subscriber of wireless system 100 would receive a data from the upper layer thereof, followed by sorting and storing the received data in a buffer 105. When an MAP decoder 103 receives the UL-MAP message from a modem 104, the MAP decoder 103 interprets the received message and informs a generic scheduler 102 of the interpreter result. The conventional generic scheduler 102 would arrange a schedule for the uplink data to be sent by the buffer 105 according to the amount and the time of the uplink data and the demand on quality of service (QoS) of each connection. A protocol data unit constructor (PDU constructor) 106 packs the data stored in the buffer 105 in medium access control (MAC) PDU format according to IEEE standard 802.16 and the data packet queues for the suitable time to be handed over to the modem 104 for sending out.

FIG. 2 is the operation flowchart of a subscriber of wireless system disclosed by U.S. Pat. No. 6,459,687. Referring to FIG. 2, the operation flowchart is intended to further explain the operation flow steps in conjunction with FIG. 1. First, the conventional subscriber of wireless system 100 conducts the actions from step S201 to step S204 during the duration of a time T201; in other words, the conventional subscriber of wireless system 100 must complete the actions of the steps S201-S204 prior to receiving a UL-MAP. In step S201, MAC receives data from the top layer unit 101. Then in step S202, the MAC sorts the received data into each connection. After that in step S203, the MAC stores the sorted data in the buffer 105 to queue for an uplink chance. Further in step S204, the MAC computes the data amount of the buffer 105 for subsequent usage.

In FIG. 2, a time T202 represents the time duration from the point at which the conventional subscriber of wireless system 100 receives the UL-MAP to an uplink burst (UL-B) assigned by the base station. The prior art needs to timely complete all tasks specified by the steps S205-S209 within the brief time T202. In a WiMAX wireless mobile communication system however, the UL-B transmission time could be arranged together with the UP-MAP in a same frame duration or arranged in the next frame duration following the UL-MAP. Once the conventional subscriber of wireless system 100 receives a UL-MAP message from the base station, the MAP decoder decodes the received UL-MAP which indicates an uplink space is available and informs the conventional generic scheduler 102 of it (step S205). Then, the conventional generic scheduler 102 computes the volume of bandwidth space available (data amount available for uplink) within the assigned time. The conventional generic scheduler 102 can also conduct step S206 to send an initial bandwidth request to the base station depending upon the practical demand. In step S207, the conventional generic scheduler 102 extracts the QoS parameters of all the connections. Further, the conventional generic scheduler 102 sets a priority for each connection to queue to uplink data (step S208).

In step S209, the conventional generic scheduler 102 informs the PDU constructor 106 of combining an uplink packet (building a data burst). Finally, in step S210, the PDU constructor 106 sends the data packet to the base station via the modem 104 within the time slot assigned by the UL-MAP.

In terms of the conventional subscriber of wireless system 100, the subscriber 100 is required to prepare the data packet at ready within the brief duration T202, so as to timely transmit the packet in a suitable time slot for ensuring the QoS. The above-mentioned conventional generic scheduler 102 in FIG. 1 is in charge of processing the QoS transmission requirements, such as a promissory rate, the highest rate and the maximum transmission delay, all of which are included in the link-building parameters between the conventional WiMAX subscriber of wireless system 100 and the base station. If the conventional subscriber of wireless system 100 fails to arrange the data in a suitable time slot for transmitting within the time T202, it would miss the present chance to uplink the data, so that the delivery of the uplink data having the real-time service request would be delayed without ensuring the QoS.

In order to make real-time applications more efficient, five QoS types are defined in the new IEEE standard 802.16e worked out in 2005, which is unsolicited grant service (UGS), real-time polling service (rtPS), extended rtPS (ErtPS), non-real-time polling service (nrtPS) and best effort (BE).

When a conventional subscriber of wireless system 100 is used in, for example, network gaming, digital music streaming, TV and other entertainment services, video meeting, image monitoring and plural kinds of real-time digital information, an overload in conjunction with the above-mentioned applications makes the subscriber 100 fail to set a priority for each connection data and to allocate bandwidths within the defined time T202.

In summary, according to the above description, since the WiMAX wireless mobile communication system is intended to simultaneously transmit different data with various attributes, therefore the system must have a mechanism to ensure the QoS; in particular, when a mobile device is served for various modem data-flows, the task to ensure the QoS request appears to be more challenging and becomes vital for the success of the applications. However, in confrontation of the various modem data-flows, a conventional subscriber of wireless system must complete various operations regarding different schedule algorithms within a brief duration from receiving a UL-MAP to the uplink time slot and timely prepare data packets at ready according to the QoS request, the priority order of all the connections and the allocated bandwidths of the connections (i.e. building a data burst is ready), which would impose an overload on the conventional subscriber of wireless system so as to make the subscriber failed to complete the job of preparing the uplink data within a defined time.

### SUMMARY OF THE INVENTION

Accordingly, the present invention is directed to an operation method of a subscriber of wireless system so as to timely prepare various uplink data of connections at the ready for meeting various QoS requests.

The present invention is also directed to a subscriber of wireless system capable of arranging data in suitable time slots within a defined time, so that the problem of lacking successive operation capability under an increasing load with a conventional wireless system can be solved and the QoS can be ensured.

The present invention provides an operation method of a subscriber of wireless system. The operation method includes the following steps. First, scheduling of data for each connection is conducted prior to decoding an MAP. Next, MAP from a base station is received. Next, the MAP is decoded. Next, a bandwidth is allocated to each connection according to the decoding result of the MAP. Next, data burst is built according to the bandwidth allocation results of all the connections. Next, the data burst is transmitted within the time assigned by the MAP.

On the other hand, the present invention provides a subscriber of wireless system, the subscriber includes a buffer, a scheduler, a modem, an MAP decoder, a bandwidth allocator and a PDU constructor. The buffer receives the data output from the upper layer unit thereof. The scheduler is coupled to the buffer for scheduling the data of each connection temporarily stored in the buffer prior to decoding the MAP. The modem provides a signal modulation/demodulation interface between the subscriber and a base station. The MAP decoder is coupled to the modem for receiving an MAP come from the base station and decoding the MAP. The PDU constructor is coupled to the bandwidth allocator, the buffer and the modem for reading out the data of each connection from the buffer according to the bandwidth allocation results of all the connections to build data burst. In addition, the modem further modulates the data burst built by the PDU constructor so as to deliver the modulated data burst to the base station. The bandwidth allocator is coupled to the MAP decoder for allocating a bandwidth to each connection according to the decoded MAP result.

Since the present invention adopts a novel scheduler and a bandwidth allocator to process data during different time, the present invention is able to avoid the problem of the prior art, in which there is not sufficient time available for a conventional scheduler to simultaneously prioritize the uplink data and process the bandwidth allocation within a single defined time. In fact, prior to receiving a UL-MAP message to be decoded, the scheduler of the invented subscriber of wireless system has prioritized in advance each connection data to be uplinked next time, therefore, when the bandwidth allocator receives the UL-MAP message to be decoded, the subscriber has sufficient time within the assigned time to complete the bandwidth allocation job, which would further advance the QoS of the system.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an architecture diagram of a conventional subscriber of wireless system.

FIG. 2 is the operation flowchart of a subscriber of wireless system disclosed by U.S. Pat. No. 6,459,687.

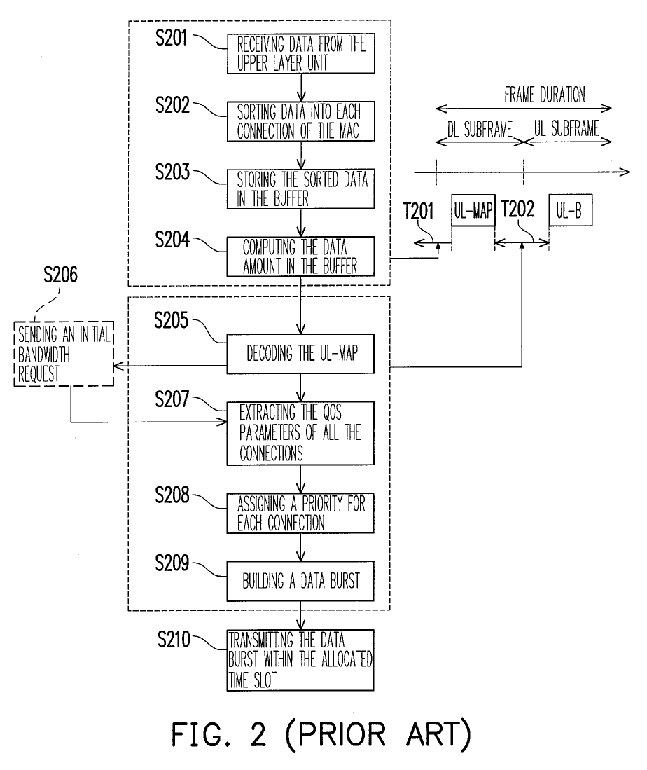

FIG. 3 is an architecture diagram of a subscriber of wireless system according to an embodiment of the present invention.

FIG. 4 is the operation flowchart of a subscriber of wireless system according to an embodiment of the present invention.

FIG. 5 is the schedule method flowchart of a scheduler according to an embodiment of the present invention.

FIG. 6 is the allocation method flowchart of a bandwidth allocator according to an embodiment of the present invention.

### DESCRIPTION OF THE EMBODIMENTS

In the following embodiment depiction, ‘a component is connected to or coupled to another component’ means the component is directly or through a between component connected to or coupled to another component.

It is well known that the time duration from receiving a UL-MAP message by a subscriber of wireless system to sending out an uplink PDU is very short, often less than a frame's time; however, a conventional generic scheduler is required to simultaneously prioritize uplink data and deal with bandwidth allocation within the brief duration. Hence, whenever an overload situation occurs, the required time to complete the above-mentioned jobs would exceed the defined time; as a result, the conventional subscriber of wireless system is unable to send out the uplink data in time and fails to effectively utilize bandwidth. Based on the above-mentioned situation, the present invention provides a subscriber of wireless system and the operation method thereof, so that an invented subscriber of wireless system is able to timely schedule, allocate resource, send out uplink data and effectively utilize bandwidth to meet all QoS requirements within a defined time. Furthermore, the subscriber must complete sending/receiving data within a duration less than a frame (for example, less than 5 ms). In the following, an embodiment is described so as to illustrate the present invention.

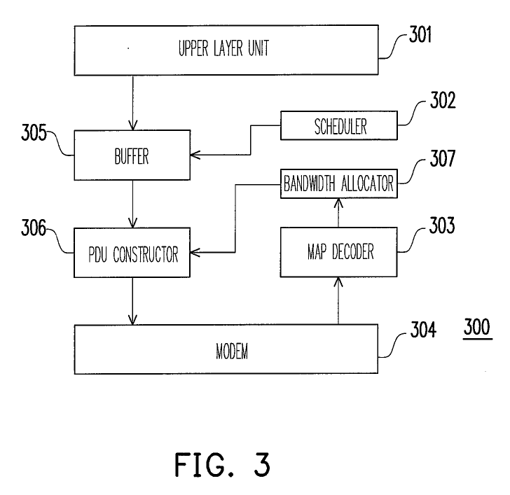

FIG. 3 is an architecture diagram of a subscriber of wireless system according to an embodiment of the present invention. The subscriber of wireless system 300 includes a buffer 305, a scheduler 302, a modem 304, an MAP decoder 303, a bandwidth allocator 307 and a protocol data unit constructor (PDU constructor) 306.

The buffer 305 is adapted for receiving the data output from the upper layer unit 301 thereof. The scheduler 302 is coupled to the buffer 305. Prior to decoding the MAP, the scheduler 302 performs sorting and schedule controlling on the data of each connection temporarily stored in the buffer 305, and temporarily stores the sorted data of each connection into the buffer 305. The modem 304 is adapted for providing a signal modulation/demodulation interface between the subscriber of wireless system 300 and a base station (not shown). The MAP decoder 303 is coupled to the modem 304 for receiving an MAP from the base station followed by decoding the MAP.

The bandwidth allocator 307 is coupled to the MAP decoder 303 for allocating a bandwidth to each connection according to the decoding result of the MAP The PDU constructor 306 is coupled between the bandwidth allocator 307, buffer 305 and the modem 304 for reading the data of each connection from the buffer 305 and building a data burst according to the bandwidth allocation result of each connection. The modem 304 herein would modulate the data burst built by the PDU constructor 306 and transmit the data burst to the base station.

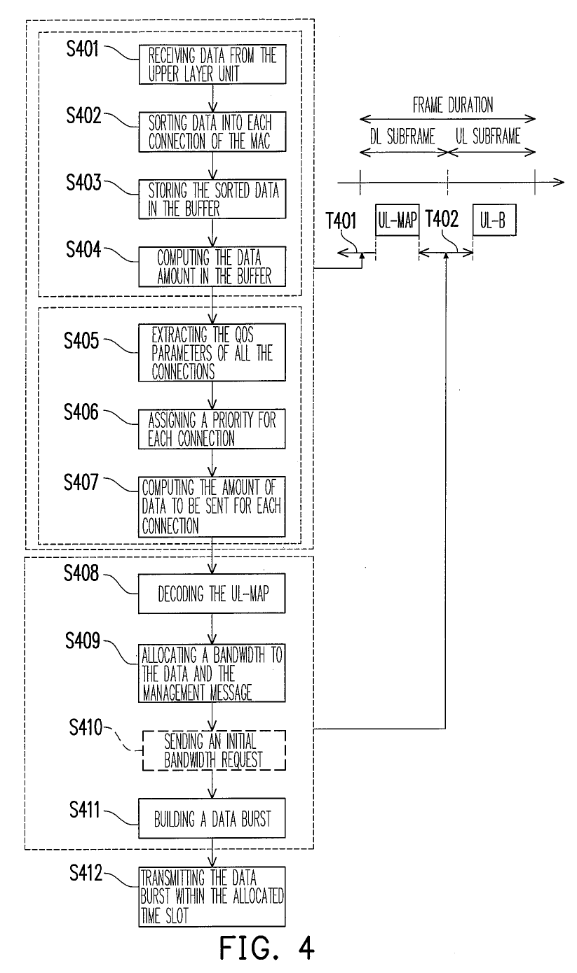

FIG. 4 is the operation flowchart of a subscriber of wireless system according to an embodiment of the present invention. Referring to FIGS. 3 and 4, the time T401 in FIG. 4 represents the time prior to obtaining a UL-MAP by the subscriber of wireless system 300, while the time T402 represents the time from receiving a UL-MAP to sending out the data burst by the subscriber of wireless system 300. In order to suit the QoS mechanism of dataflow in divers types, the present embodiment would reduce workload within the time T402, so as to complete the bandwidth allocation job within the brief time T402 and hereby enhance the QoS of the system. For example, all tasks unrelated to a UL-MAP message should be completed prior to receiving a UL-MAP message.

Continuing to the operation flowchart shown by FIG. 4, the steps S401-S407 in the present embodiment can be completed in advance prior to receiving a UL-MAP message, i.e. completed within the time T401. The buffer 305 receives the data from the upper layer unit 301 via the MAC (step S401). By means of the control of the scheduler 302, the MAC is able to sort the received data to each connection (step S402) and store the sorted data in the buffer 305 to await for an uplink chance (step S403). The scheduler 302 also computes the data amount in the buffer 305 for the subsequent scheduling use (step S404). Prior to receiving a UL-MAP message (within the time T401), the scheduler 302 further extracts the QoS parameters of the data of each connection (step S405). The scheduler 302 furthermore sets a priority for each connection according to the QoS parameter of the connection (step S406) and computes the maximum value and the minimum value of the data amount of each connection waiting for delivery in each uplink duration (step S407). Those skilled in the art would be able to select a suitable algorithm for scheduling data to implement the above-mentioned scheduler 302 according to the present invention and the disclosures of the embodiments, which shall be construed to be within the scope of the present invention.

Once the MAP decoder 303 of the subscriber of wireless system 300 receives a UL-MAP message sent by the base station via the modem 304 (the time T402), the UL-MAP would be decoded immediately (step S408). The UL-MAP carries the information of bandwidth space in the present UL subframe allocated to the subscriber of wireless system 300 by the base station. Thus, the bandwidth allocator 307 immediately computes the uplink data amount allowed by the available bandwidth space according to the decoding result of the MAP decoder 303 and allocates the bandwidth to the necessary management message, the bandwidth request message and the data to be uplinked for each connection (step S409). The bandwidth allocator 307 sends out an initiative bandwidth request to the base station depending on the requirement (step S410). Then, the PDU constructor 306 reads the corresponding data from the buffer 305 and combines the data into an uplink data packet, i.e. building a data burst (step S411). In the end, the PDU constructor 306 transmits the data packet to the base station via the modem 304 in the time slot UL-B allocated by the base station (step S412).

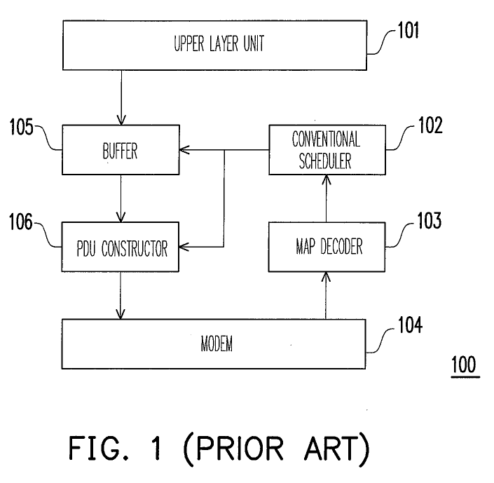

The difference between FIG. 1 and FIG. 3 is obvious. The conventional scheduler 102 in FIG. 1 must determine a priority for each connection, schedule, allocate bandwidth and construct a data packet (i.e. building a data burst) within the brief time T202, which, in an application environment with a heavy dataflow burden of various multimedia, makes the conventional subscriber of wireless system 100 fail to timely complete the preparation actions for uplinking data due to the overload. Alternatively, the present embodiment hands over all jobs unrelated to UL-MAP to the scheduler 302 for implementation, so as to complete scheduling data, computing the maximum uplink amount and the minimum uplink amount of each connection and so on in advance, i.e. prior to receiving an UL-MAP (the time T401 in FIG. 4). However, all jobs closely related to UL-MAP are assigned to the bandwidth allocator 307 to complete. Thus, once receiving an UP-MAP (shifting to the time T402 in FIG. 4 at this time), a bandwidth would be allocated to each connection according to the received UL-MAP.

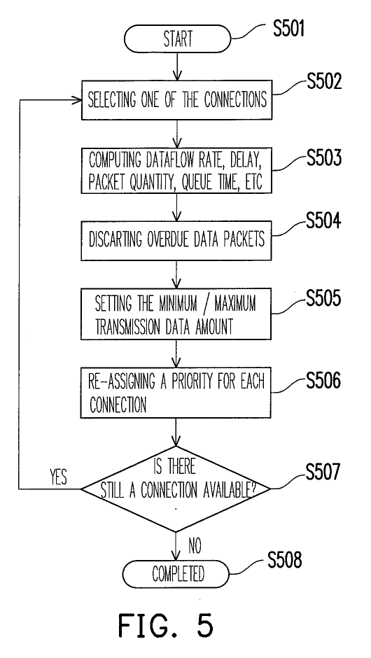

FIG. 5 is a schedule method flowchart of a scheduler according to an embodiment of the present invention. With the present embodiment, the operation method of the scheduler 302 and the flow thereof would be explained in more details. All data to be transmitted should be concentrically allocated in a same frame according to the demand of a mobile WiMAX on QoS. Meanwhile, the available service source should be scheduled in optimum manner in coordination with the delay time for each service request is able to tolerate and without affecting the QoS thereof, wherein the above-mentioned subscriber of wireless system exemplarily is, but not limited to, a handset or a personal digital assistant (PDA).

First, whenever the scheduler 302 is enabled (step S501), the scheduler would establish at least a relevant connection by utilizing data information or multimedia data such as voice, image and so on (step 502). The scheduler 302 examines the parameters related to QoS demands for each connection, for example, data flow, delay, packet, queue time and so on, computes the data of each connection and sets a priority order, from low to high, to the data of each connection according to the dataflow rate, delay time, packet quantity and queue time, all of which must be tolerated by the service requests (step S503). Then, all overdue data packets or the packets that need not be deliver among all the scheduled connections would be deleted (step S504). At this time, the scheduler 302 would sequentially take out the service requests with a shorter delay time, compute both the minimum data amount and the maximum data amount (i.e. the minimum transmission data amount and the maximum transmission data amount) for each connection to be able to deliver if a delivery chance occurs and allocate the data to be transmitted to the corresponding frame (step S505).

Further, the scheduler 302 re-assigns a priority for each connection data (step S506). The scheduler 302 further computes the bandwidth for each connection to ask the base station to allocate and stores all the computation results into a memory. In step S507, the scheduler decides whether the data of all service requests are allocated already. Once there is still a data having the service request not to be allocated, the method flow would return to step S502 and a next service request would be scheduled. In the end, if all data have been allocated, it indicates the scheduler 302 has completed scheduling the service resource, and the connections await for uplink chances (step S508).

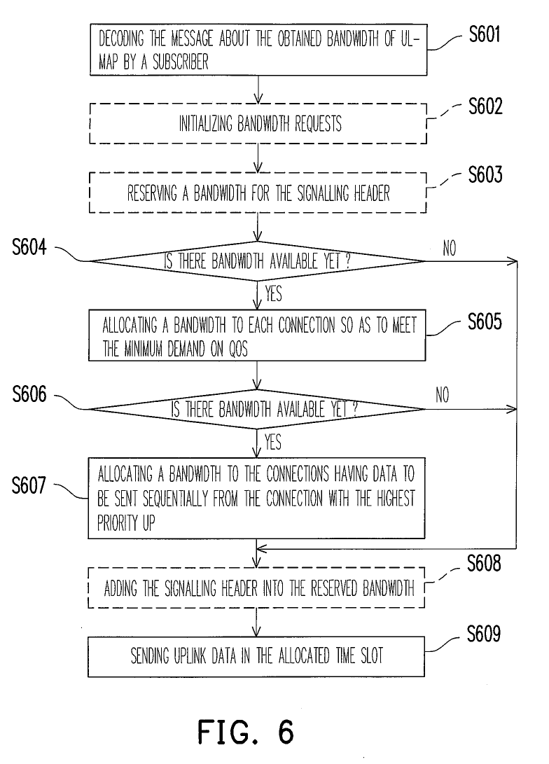

FIG. 6 is an allocation method flowchart of a bandwidth allocator 307 according to an embodiment of the present invention. The present embodiment would explain the flow of the allocation method of the bandwidth allocator 307 in more details. First, the bandwidth allocator 307 receives the UL-MAP message decoded and sent by the MAP decoder (step S601). The bandwidth allocator 307 initializes bandwidth requests depending on the demands (step S602). In addition, the bandwidth allocator 307 can also reserve a bandwidth for the signaling header to be sent out at first (step S603), so as to ensure the signaling header can be sent out. Alternatively, a piggyback manner can be used to deliver bandwidth requests and at this time the signaling header is not necessary to be sent, which can save the bandwidth spent expectedly by sending the bandwidth requests.

Then, the bandwidth allocator 307 is allowed to continuously examine whether the bandwidth volume is sufficient (step S604). When the bandwidth volume is sufficient, a bandwidth would be allocated to each connection according to the minimum demand of each connection (step S605). Meanwhile, it is validated that whether sending a bandwidth request of piggyback is necessary. Thus, step S605 should be able to satisfy the QoS of the minimum transmission data amount for each connection. Further in step S606, if there is a bandwidth surplus at this time, the allocation flow would go to step S607, where a bandwidth would be re-allocated to each connection according to the demand of the connection, but the re-allocated bandwidth is not allowed to exceed the maximum transmission data amount permitted by each connection. During performing step S606 however, if the bandwidth space is used out, the flow would skip to step S608. In step S608, the bandwidth allocator 307 can decide whether step S608 needs to be conducted depending on the requirement, and in this way the signaling header is added into the list of the bandwidth reserved by step S603. In the end, all data to be uplinked are allocated in a time slot (which means a data burst is built already), scheduling the bandwidth allocation is completed and the uplink data is sent in the time slot UL-B (step S609).

In summary, since the subscriber of wireless system and the operation method thereof provided by the present invention adopt a novel scheduler which sets a priority in advance for each connection data to be uplinked next time, therefore, when the bandwidth allocator receives a decoded UL-MAP message, there is sufficient time to complete the bandwidth allocation job. The subscriber of wireless system of the present invention is able to complete scheduling, allocate resource, send out uplink data and effectively utilize bandwidth to enhance the QoS of the system. The most significant advantage herein is that the system can complete sending/receiving data within the defined duration less than a frame.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A operation method of a subscriber of wireless system, comprising:
scheduling data for each connection prior to decoding a MAP;
receiving the MAP from a base station;
decoding the MAP;
allocating a bandwidth to each connection according to the result of decoding the MAP;
building a data burst according to the result of allocating bandwidth to each connection; and
transmitting the data burst within a time defined by the MAP.

2. The operation method of a subscriber of wireless system according to claim 1, further comprising:
receiving data to be delivered;
sorting the data according to the connection to which the data belongs to; and
temporally storing the sorted data.

3. The operation method of a subscriber of wireless system according to claim 1, wherein the step of scheduling data for each connection comprises:
extracting a quality of service (QoS) parameter of each connection;
setting a priority order for each connection; and
computing data amount to be delivered to each connection.

4. The operation method of a subscriber of wireless system according to claim 3, wherein the step of computing the data amount to be delivered of each connection comprises:
computing dataflow rate, delay, packet quantity and queue time; and
setting a minimum transmission data amount and a maximum transmission data amount according to a computation result and the QoS parameter.

5. The operation method of a subscriber of wireless system according to claim 4, wherein the step of computing the data amount to be delivered of each connection further comprises:
discarding overdue data packets; and
re-prioritizing each connection.

6. The operation method of a subscriber of wireless system according to claim 4, wherein the step of allocating a bandwidth to each connection comprises:
allocating a bandwidth to each connection according to the minimum transmission data amount of each connection; and
allocating a bandwidth surplus to each connection according to the priority order of the connection if a bandwidth volume is not yet to be allocated.

7. The operation method of a subscriber of wireless system according to claim 1, wherein the MAP comprises UL-MAP.

8. A subscriber of wireless system, comprising:
a buffer, used for receiving data output from the upper layer unit thereof;
a scheduler, coupled to the buffer for scheduling data of each connection temporally stored in the buffer prior to decoding a received MAP;
a modem, for providing a signal modulation/demodulation interface between the subscriber and a base station;
an MAP decoder, coupled to the modem for receiving the MAP sent from the base station and decoding the received MAP;
a bandwidth allocator, coupled to the MAP decoder for allocating a bandwidth to each connection according to a decoding result of the MAP decoder; and
a protocol data unit constructor (PDU constructor), respectively coupled to the bandwidth allocator, the buffer and the modem for reading out the data of each connection and building a data burst according to a bandwidth allocation result of each connection;
wherein the modem modulates the data burst built by the PDU constructor so as to send the modulated data burst to the base station.

9. The subscriber of wireless system according to claim 8, wherein by means of controlling the scheduler, the buffer sorts the data output by the upper layer unit thereof according to a connection to which the data belongs to and temporally stores the sorted data.

10. The subscriber of wireless system according to claim 8, wherein the scheduler extracts the QoS parameter of each connection via the buffer, and sets a priority order for each connection according to the QoS parameter of the connection and computes the data amount to be delivered to each connection.

11. The subscriber of wireless system according to claim 10, wherein the scheduler further computes the dataflow rate, delay, packet quantity and queue time, and sets the minimum transmission data amount and the maximum transmission data amount for each connection according to a computation result and the QoS parameter.

12. The subscriber of wireless system according to claim 11, wherein the scheduler discards the overdue data packets and re-prioritizes each connection.

13. The subscriber of wireless system according to claim 11, wherein the bandwidth allocator allocates a bandwidth to each connection according to the minimum transmission data amount of the connection; if there is a bandwidth volume not to be allocated yet, the bandwidth surplus would be allocated by the bandwidth allocator to each connection according to the priority order of the connection, wherein the allocated bandwidth sum of each connection does not exceed the maximum transmission data amount.

14. The subscriber of wireless system according to claim 8, wherein the MAP comprises UL-MAP.
